(19) United States
(12) Patent Application Publication
(10) Pub. No.: US 2014/0166397 A1
(43) Pub. Date: Jun. 19, 2014

(54) Ladder Stabilization Clamp

(71) Applicant: Chad Reynolds, Boulevard, CA (US)

(72) Inventor: Chad Reynolds, Boulevard, CA (US)

(21) Appl. No.: 14/101,293

(22) Filed: Dec. 9, 2013

Related U.S. Application Data
(60) Provisional application No. 61/734,869, filed on Dec. 7, 2012.

(51) Int. Cl. E06C 7/18

(52) U.S. Cl. CPC E06C 7/188
USPC 182/107; 29/428

(57) ABSTRACT

A ladder stabilization clamp consisting of a structure attachment assembly having adjustable upper and lower jaws, a ladder attachment assembly having an adjustable ladder clamp and an adjustable base to change the overall length of the ladder stabilization clamp. The ladder stabilization clamp is used to secure any type of ladder to a structure by clamping the adjustable ladder clamp to a portion of the ladder, adjusting the overall length of the ladder stabilization clamp to the distance from the ladder to a support structure and adjusting the upper and lower jaws to clamp onto the support structure. The adjustability of the ladder stabilization clamp allows it to be used on all commercially available ladders and most support structures. The ladder stabilization clamp provides safety and security while using a ladder by keeping the ladder stable by firmly securing it to a support structure.

### RELATED APPLICATION

This application claims the benefit of priority to U.S. Provisional Patent Application Ser. No. 61/734,869 filed Dec. 7, 2013, entitled “Ladder Stabilization Clamp”, and currently co-pending.

### FIELD OF THE INVENTION

The present invention relates generally to ladders and ladder accessories. The present invention is more particularly, though not exclusively, related to a ladder stabilizer.

### BACKGROUND OF THE INVENTION

Ladders have been used for centuries to enable people to reach high areas previously inaccessible. Ladders are used every day by people at their jobs or in their homes in varying environments. For instance, a homeowner may use a ladder to clean out the gutters of their home on a sunny day while a landscaper may use it to trim a branch off a tree during a wind storm. The varying use of the ladder in different environments and at different heights creates a high risk of injury. Every year thousands of people are injured and hundreds die from falling off ladders.

Several types of ladders exist such as extension ladders, telescoping ladders, step ladders, folding ladders, and platform ladders with each type having a certain degree of risk when in use. Extension ladders and telescoping ladders comprise of two vertical poles, called stiles, with a varying number of steps, called rungs, connected between the two stiles. These ladders typically have a base, or lower end, resting on a base surface, such as the ground, and its upper end leaning against a support structure, such as but not limited to a wall or roof eaves. Step ladders, folding ladders, and platform ladders generally have a base consisting of four contact points with the ground allowing these types of ladder to be used independent of a support structure. Due to the construction of these different types of ladders, ladders are inherently susceptible to tipping backwards or slipping sideways.

For extension ladders and telescoping ladders, the reliance on gravity and frictional forces to support the ladder leads to stability problems as both the upper and lower ends of the ladder are free to move. The problem is particularly prevalent when the support structure is a smooth surface, such as an aluminum fascia of a roof top, which does not provide adequate friction force to prevent the upper end of the ladder from slipping from side to side. The same problem can arise when the ladder is not at the correct angle to sufficiently prevent the upper portion of the ladder from tipping backwards away from the support structure when in use. Additionally, the gravitational and frictional forces used to keep the ladder stationary against the support structure can be overcome by the force of strong winds, either tipping the ladder backwards or sliding the ladder sideways.

For step ladders, folding ladders and platform ladders, not relying on a support structure leads to stability problems. When in use, the contact points of these ladders may not be in the optimum position and may cause the ladder to shift when in use and potentially tip over. Additionally, the forces used to keep the ladder stationary can be overcome by strong winds and cause the ladder to fall.

In light of the above, it would be advantageous to provide an effective, compact, versatile, inexpensive and easy-to-use device to stabilize and prevent a ladder from sliding sideways, tipping backwards, and shifting.

### SUMMARY OF INVENTION

The ladder stabilization clamp of the present invention includes a structure attachment assembly having an adjustable clamp and a ladder attachment assembly that includes an adjustable base and adjustable ladder clamp. The adjustable base is the point of attachment between the clamping assembly and the ladder attachment assembly.

The ladder stabilization clamp stabilizes a ladder by securing the ladder to a support structure. The ladder stabilization clamp of the present invention is fastened to the ladder by connecting the adjustable ladder clamp one of the ladder's upper rungs. The diameter of the adjustable ladder clamp may be adjusted to accommodate different sized ladder rungs. The adjustable base is then adjusted to allow the structure attachment assembly to reach and be secured to an anchoring point on the support structure. By extending or shortening the adjustable base, the overall length of the ladder stabilization clamp can be changed to accommodate various distances between the ladder and support structure. The structure attachment assembly is secured to the support structure by adjusting the lower and upper jaws to the appropriate thickness of the anchoring point. The clamp pads grip onto the anchoring point and prevent the lower and upper jaws from slipping and damaging the anchoring point.

The ladder stabilization clamp of the present invention secures any type of ladder to a support structure to increase stability and prevent the ladder from sliding, tipping backwards and shifting. This product will provide an increased level of safety and peace of mind to people using ladders.

### BRIEF DESCRIPTION OF DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a side view of the ladder stability clamp of the present invention showing the structure attachment assembly connected to the adjustable base which is integrally formed with the ladder attachment assembly;

FIG. 2 is a side view of the structure attachment assembly with the lower and upper jaw assemblies adjusted to the thickness of a wood fascia, pressing the upper and lower jaw clamp pads firmly against the wood fascia;

FIG. 3 is a side view of the ladder attachment assembly comprising of an adjustable base with several adjustment points, an adjustable ladder clamp with an adjustable diameter, and the fastener used to attach the ladder attachment assembly to the structure attachment assembly;

FIG. 4 is a side view of the ladder stability clamp of the present invention and shows the structure attachment assembly firmly gripping the fascia of the house, the ladder attachment assembly attached to an upper ladder rung of the ladder and the adjustable base adjusted to the correct length to allow the clamp to be used between the ladder and the house;

FIG. 5a is a side view of an alternative embodiment of the present invention showing the structure attachment assembly, the adjustable base with an adjustment channel and ladder attachment assembly;

FIG. 5b is a side view of the adjustable base with an adjustment channel and ladder attachment assembly;

FIG. 6a is a side view of an alternative embodiment of the present invention showing the structure attachment assembly, the adjustable base with an adjustment channel and a ladder attachment assembly with quick release adjustable ladder clamp;

FIG. 6b is a side view of the adjustable base with an adjustment channel and ladder attachment assembly with a quick release adjustable ladder clamp;

FIG. 7a is a perspective view of an adjustable length rod with a secondary tube inserted in the primary tube at a depth determined by the adjustment points and a release button to allow the secondary tube to be adjusted to different adjustment points, changing the overall length of the adjustable length rod;

FIG. 7b is a front view of an adjustable length rod inserted through a ladder rung with a ladder stabilization clamp clamped to each end of the adjustable length rod and end caps on the primary and secondary clamps to prevent the adjustable length rod from sliding too far into the ladder rung and to prevent the ladder stability clamp from sliding itself off of the adjustable length rod;

FIG. 8a is a front view of an alternative embodiment of the present invention showing the structure attachment assembly, the adjustable base with an adjustment channel and adjustable ladder stile attachment assembly;

FIG. 8b is a top view of the adjustable base with the adjustment channel and ladder attachment assembly with the rectangular shaped adjustable ladder stile attachment assembly; and

FIG. 8c is a side view of the ladder stability clamp of the present invention and shows the ladder attachment assembly attached to the outer edge of a ladder stile away from the stepping area of the ladder rung.

### DETAILED DESCRIPTION OF DRAWING

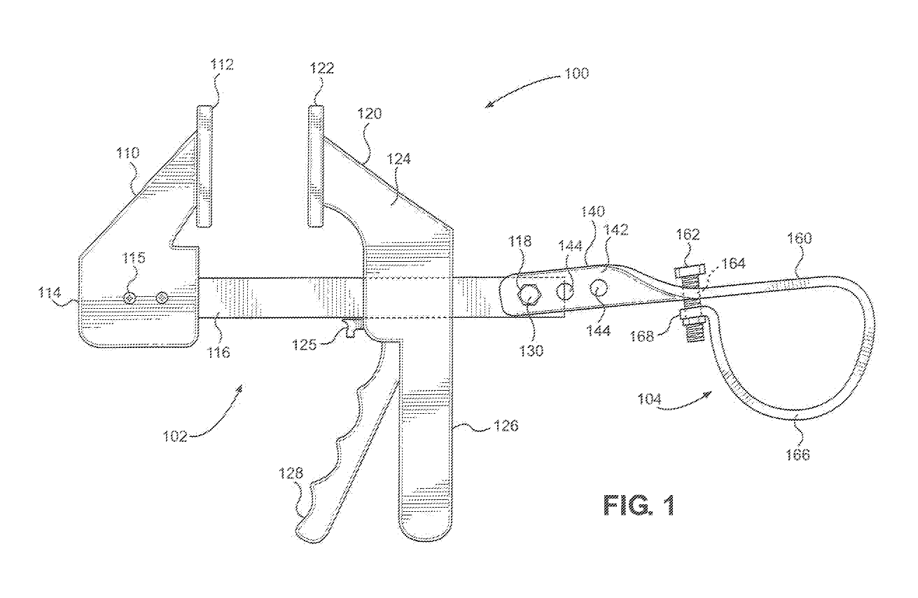

Referring initially to FIG. 1, the ladder stabilization clamp of the present invention is shown and generally designated 100, and includes a structure attachment assembly generally labeled 102 and a ladder attachment assembly generally labeled 104. Structure attachment assembly 102 includes an upper jaw assembly 110 and lower jaw assembly 120. The upper jaw assembly 110 includes an upper jaw clamp pad 112, an upper jaw 114, a support rail 116, and structure attachment assembly connecting point 118. The upper jaw clamp pad 112 is made from any material known in the art suitable for high impact and constant use while providing a non-slip, non-marring surface. For instance, upper jaw clamp pad 112 may be made from a soft, yet durable, plastic or rubber. Upper jaw clamp pad 112 is attached to the upper jaw 114 by any suitable means known in the art, such as by an adhesive or by a friction fit.

As shown in this Figure, the upper jaw 114 is constructed to provide a flat contact surface on one end and a base to receive support rail 116 on the other end. Upper jaw 114 may be made from a strong, durable, and lightweight plastic or other suitable material. The upper jaw clamp pad 112 is attached to the flat contact surface of the upper jaw 114 to provide a non-marring and non-slip surface. The base of the upper jaw 114 is shown receiving the support rail 116. Support rail 116 is inserted into the base of the upper jaw 114 and secured with hardware 115. Connecting point 118 is formed in the opposite end of the support rail 116, providing a mounting point connecting structure attachment assembly 102 to ladder attachment assembly 104.

Support rail 116 is inserted through the lower jaw assembly 120 and provides the lower jaw assembly 120 a surface upon which to traverse when the structure attachment assembly 102 is in use. The upper jaw assembly 110 is stationary relative to the motion of the lower jaw assembly 120. The lower jaw assembly 120 traverses along the support rail 116 to either increase or decrease the distance between the upper jaw assembly 110 and lower jaw assembly 120. The support rail 116 is made from durable, high strength steel or any material with similar characteristics. It is necessary that support rail 116 be of suitable strength and durability, as it is the major support member of the present invention and bears the majority of strain within the system.

The lower jaw assembly 120 includes a lower jaw clamp pad 122, a lower jaw 124, a release button 125, a stationary handle 126, and a ratchet handle 128. The lower jaw clamp pad 122 is made from the same material as the upper jaw clamp pad 112 and is attached to the lower jaw 124 using the same adhesive or friction method. The lower jaw 124 is constructed to provide a flat contact surface opposite upper jaw 114 and forms the other half of the structure attachment assembly 102. The bottom of the lower jaw 124 is formed with stationary handle 126, and ratchet handle 128 fit within the stationary handle 126. To reduce cost and manufacturing time, the lower jaw 124 and stationary handle 126 may be integrally formed into a single piece.

The ratchet handle 128 is attached to the lower jaw 124 by a hinge and spring mechanism (not shown this Figure), allowing the ratchet handle 128 to rotate toward the stationary handle 126 when squeezed by the user. It is to be appreciated that a hinge and spring should not be considered limiting, and other suitable mechanisms may be employed without departing from the present invention.

The point of attachment creates a pivot point for the ratchet handle 128 to pivot. Stationary handle 126 supports a user's palm while allowing the user to apply force from the user's fingers to squeeze the ratchet handle 128. By squeezing the ratchet handle 128, the ratchet handle 128 pivots towards the stationary handle. The repeated squeezing of the ratchet handle 128 will cause the lower jaw assembly 120 to incrementally traverse along the length of the support rail 116 allowing the user to set the structure attachment assembly 102 to the desired width and pressure. The positioning of the ratchet handle 128 away from the user allows the user to apply optimal force while standing on a ladder behind the ladder stabilization clamp 100. The release button 125 may be depressed to allow the lower jaw assembly 120 to move freely along the support rail 116.

The ladder attachment assembly 104 includes an adjustable base 140 and an adjustable ladder clamp 160. The adjustable base 140 includes a body 142 and attachment points 144. As shown, attachment points 144 are three evenly spaced holes in the body 142. The body 142 is integrally formed with the adjustable ladder clamp 160 to provide strength, durability, and ease of manufacturing. The number of attachment points 144 or their spacing should not be considered limiting, as any reasonable number of attachment points 144 may be employed, and may serve to extend or shorten the overall reach of the ladder stabilization clamp 100.

The adjustable ladder clamp 160 includes an adjustment screw 162, stationary adjustment hole 164, loop 168, and tab 168. The stationary adjustment hole 164 is located between the ends of the adjustable base 140 and adjustable ladder clamp 160. The loop 166 is formed by bending a flat metal bar strip approximately 180 degrees to obtain a circular shape with one end of the circular shape relatively flat. The tab 168 is located at the end of the loop and is integrally formed with the loop 166. The tab 168 is bent at an angle to provide a contact surface for adjustment screw 162 and stationary adjustment hole 164. The tab 168 has an integral hole to accept the adjustment screw 162 as it is inserted through stationary adjustment hole 164. Tab 168 may alternatively be internally threaded to accept the external threads of adjustment screw 162. By tightening or loosening the adjustment screw 162, the diameter of the loop 166 may be increased or decreased.

As shown, the attachment points 144 of the adjustable base 140, provides an attachment point for the structure attachment assembly connecting point 118. By choosing one of the attachment points 144 on the adjustable base 140 as a connecting point for structure attachment assembly connecting point 118, the overall length of the ladder stabilization clamp 100 may be changed to cover various distances between a ladder and a support structure.

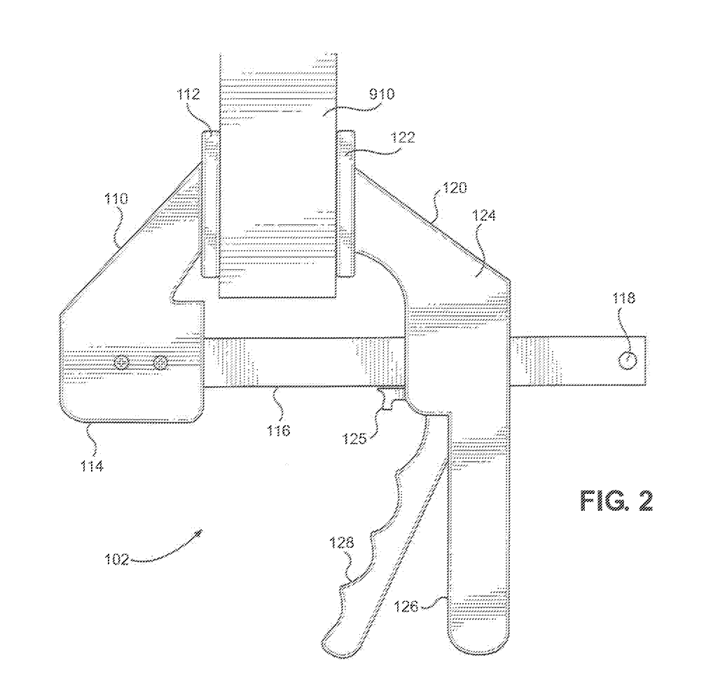

Referring now to FIG. 2, a side view of the structure attachment assembly 102 of the ladder stabilization clamp 100 is shown. The structure attachment assembly 102 includes the upper jaw assembly 110 and lower jaw assembly 120. As shown, the distance between the upper jaw 114 and lower jaw 124 is adjusted to the thickness of a wood fascia 910 of a support structure. Upper jaw clamp pad 112 and lower jaw clamp pad 122 are firmly pressed against the wood fascia 910 and provides a non-marring and non-slip interface between the upper jaw 114, lower jaw 124 and the wood fascia 910. The upper jaw clamp pad 112 and lower jaw clamp pad 122 is made from a soft, yet durable, plastic or rubber to prevent the clamping force of the upper jaw assembly 110 and lower jaw assembly 120 from damaging the wood fascia 910. Additionally, the material of the upper jaw clamp pad 112 and lower jaw clamp pad 122 provides adequate friction to create a non-slip surface.

Release button 125 can be depressed to release the compression of the upper jaw assembly 110 and lower jaw assembly 120 on the wood fascia 910. By depressing the release button 125 the lower jaw assembly 120 is free to traverse along the support rail 116.

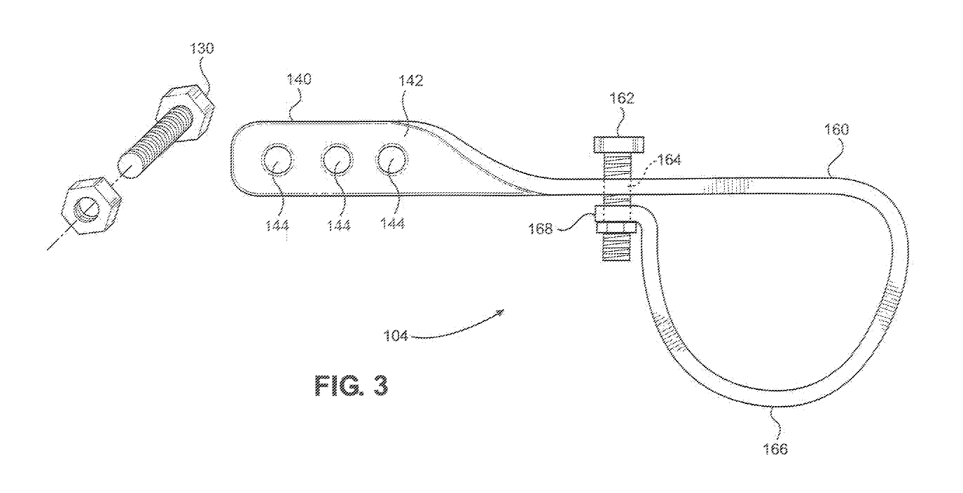

Referring now to FIG. 3, a side view of the ladder attachment assembly 104 of the ladder stabilization clamp 100 is shown. The ladder attachment assembly 104 includes the fastener 130, the adjustable base 140, and adjustable ladder clamp 160. As shown, the adjustable base 140 is integrally formed with the adjustable ladder clamp 160 to provide strength, durability, and ease of manufacturing. In a preferred embodiment, the adjustable base 140 and adjustable ladder clamp 160 is formed using a single flat metal bar strip. The adjustable base 140 consists of the initial portion of the flat metal bar strip. At the end of the adjustable base 140, the flat metal bar strip is transitioned into the adjustable ladder clamp 160 by twisting the flat metal bar strip 90 degrees along the flat metal bar strip's longitudinal axis.

As shown, the diameter of the adjustable ladder clamp 160 can be changed by adjusting the diameter of the loop 166 by tightening or loosening the adjustment screw 162. Tightening or loosening the adjustment screw 162 moves the tab 168 towards or away from the stationary adjustment hole 164 resulting in an increase or decrease of the diameter of the loop 166. By inserting the fastener 130 through one of the attachment points 144 and the connecting point 118 of the structure attachment assembly 102, the overall length of the ladder stabilization clamp 100 can be changed. The fastener 130 allows for rotational movement between the ladder attachment assembly 104 and the structure attachment assembly 102 to obtain a desired angular position. By tightening the fastener 130, the ladder attachment assembly 104 and the structure attachment assembly 102 can be held at the desired angle.

In an alternative embodiment, the loop 166 of ladder clamp 160 may be formed from a flexible material such as nylon webbing, providing a durable clamping mechanism, yet flexible and adjustable for various applications. Such an embodiment can utilize a strap clamp (not shown) or hardware similar to adjustment screw 162 in order to size loop 166 to the appropriate size and further secure the loop 166 in place. This alternative embodiment can further incorporate a flexible adjustable base 140 constructed completely of a strong flexible material such as nylon webbing or other similar materials known in the art.

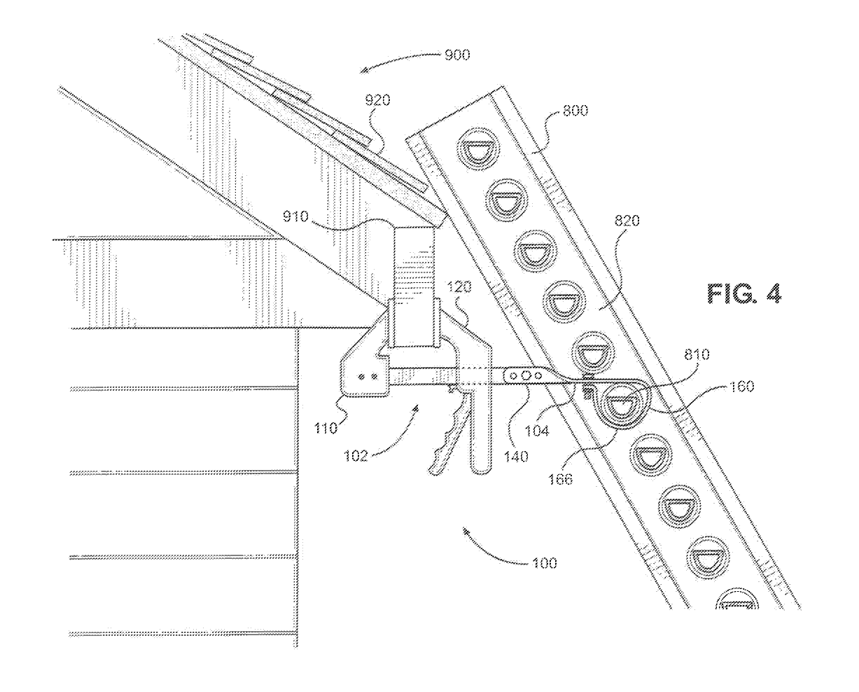

FIG. 4 is a side view of the ladder stabilization clamp 100 with a cross sectional view of a house 900 and a ladder 800. As shown, the ladder 800 is leaning against the roof 920 of the house 900. The ladder attachment assembly 104 is connected to the ladder rung 810 of the ladder 800 by sliding loop 166 around rung 810 and then tightening adjustment screw 162, securing the ladder stabilization clamp 100 in place. The length of the ladder stabilization clamp 100 is adjusted to meet the distance between the ladder rung 810 and the wood fascia 910 of the house 900 by adjusting the adjustable base 140 accordingly. The structure attachment assembly 102 is clamped onto the wood fascia 910 by adjusting the distance between the upper jaw assembly 110 and lower jaw assembly 120 until adequate force is applied to the wood fascia 910 to keep the structure attachment assembly 102 firmly in place.

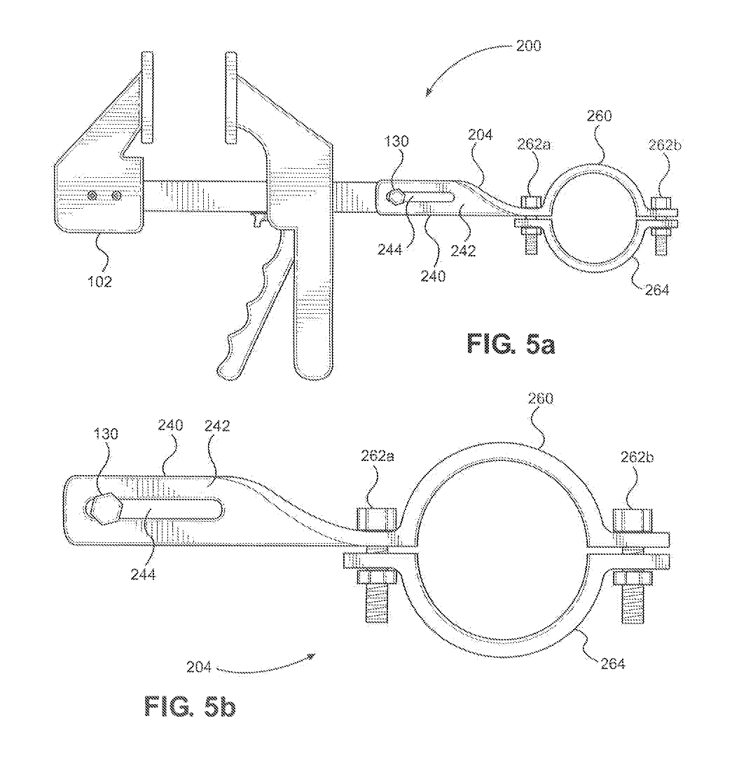

Referring now to FIG. 5a, a side view of an alternative embodiment of the ladder stabilization clamp 200 is shown. The ladder stabilization clamp 200 includes a structure attachment assembly 102, similar to that described above and a ladder attachment assembly 204. The ladder attachment assembly 204 includes an adjustable base 240 and an adjustable ladder clamp 260. The adjustable base 240 includes a body 242 and an adjustment channel 244. The adjustment channel 244 is formed into the body 242 wide enough to accommodate the width of fastener 130. The body 242 is integrally formed with the adjustable ladder clamp 260 to provide strength, durability, and ease of manufacturing.

The adjustable ladder clamp 260 includes adjustment screws 262a and 262b and a circular clamp 264. The top portion of the circular clamp 264 is integrally formed with the body 242 of the adjustable base 240. The circular clamp 264 comprises of two semi-circles. Each semi-circle has extended tabs at each end, with each end having holes formed to accept adjustment screws 262a and 262b. The corresponding holes of the tabs of each half are aligned to create a full circular shape. The adjustment screws 262a and 262b are then inserted through the holes. The tightening or loosening of the adjustment screws 262a and 262b will increase or decrease the overall diameter of the circular clamp 260, securing ladder stabilization clamp 200 to a particular ladder 800.

As shown, the adjustment channel 244 of the adjustable base 240 provides an attachment point for the structure attachment assembly connecting point 118. By sliding the structure attachment assembly connecting point 118 and the fastener 130 along the adjustment channel 244, the overall length of the ladder stabilization clamp 200 may be changed to cover different distances between a ladder and a support structure. The fastener 130 allows for rotational movement between the structure attachment assembly 102 and ladder attachment assembly 204. By tightening the fastener 130, the structure attachment assembly 102 and the ladder attachment assembly 204 can be held at the desired angle and length.

Referring now to FIG. 5b, a side view of an alternative embodiment of the ladder attachment assembly 204 of the ladder stabilization clamp 200 is shown. The ladder attachment assembly 204 includes an adjustable base 240 and an adjustable ladder clamp 260. As shown, the adjustable base 240 is integrally formed with the adjustable ladder clamp 260 to provide strength, durability, and ease of manufacturing. In a preferred embodiment, the adjustable base 240 and adjustable ladder clamp 260 is formed using a single flat metal bar strip. The adjustable base 240 consist of the initial portion of the flat metal bar strip. At the end of the adjustable base 240, the flat metal bar strip is transitioned into the adjustable ladder clamp 260 by twisting the flat metal bar strip 90 degrees along the longitudinal axis.

As shown, the diameter of the adjustable ladder clamp 260 can be changed by tightening or loosening the adjustment screw 262a and 262b. The tightening or loosening of the adjustment screws 262a and 262b moves the bottom half of the circular clamp 264 towards or away from top half of the circular clamp 264 resulting in an increase or decrease of diameter.

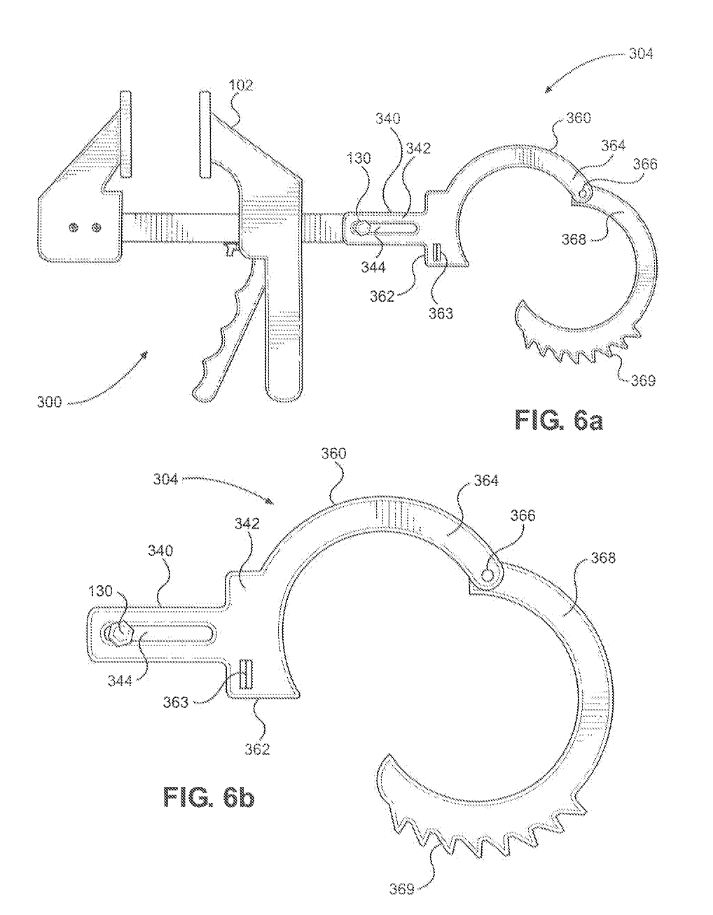

Referring now to FIG. 6a, a side view of an alternative embodiment of the ladder stabilization clamp 300 is shown. The ladder stabilization clamp 300 includes a structure attachment assembly 102 and a ladder attachment assembly 304. The ladder attachment assembly 304 includes an adjustable base 340 and a quick release clamp 360. The adjustable base 340 includes a body 342 and an adjustment channel 344, similar to previous Figures. As shown, the adjustment channel 344 is a channel formed in the body 342 wide enough to accommodate the width of fastener 130. The body 342 is integrally formed with the adjustable ladder clamp 360 to provide strength, durability, and ease of manufacturing.

The quick release clamp 360 includes a receiver 362, a stationary arm 364, a swivel point 366, a swivel arm 368, teeth 369 and a release button 363. The adjustable base 340 is integrally formed with the receiver 362 and the stationary arm 364. The swivel arm 368 is attached to the stationary arm 364 at the swivel point 366. The swivel point 366 can be a hinge, rivet, or other hinge-like mechanism known in the art capable of fastening two pieces together while allowing a rotational movement. The swivel arm 368, the stationary arm 364, and the receiver 362 form a circular shape when connected together that surrounds a ladder rung 810 or ladder stile, securing the ladder 800 in place. In an alternative embodiment, the shape of quick release clamp 360 can be a shape other than circular in order to accommodate different shaped ladder structures.

The free end of the swivel arm 368 is inserted into the receiver 362 and the teeth 369 formed on the swivel arm 368 mate with teeth (not shown) on the interior of the receiver 362, securing the swivel arm 368 within the receiver 362. The shape of teeth 369 and the teeth on the interior portion of receiver 362 are shaped in such a way allowing quick release clamp 360 to be tightened by simply applying inward pressure to the swivel arm 368. The swivel arm 368 may be rotated in the reverse direction, back out of the receiver 362 by depressing the release button 363, the teeth on the interior of the receiver 362 are disengaged from teeth 369, releasing the ladder rung 810 or ladder stile from quick release clamp 360. By inserting the swivel arm 368 into the receiver 362 at the desired angular position, the diameter of the quick release clamp 360 can be adjusted. In an embodiment, the swivel arm 368 may be rotated 360 degrees in a linear motion and passed through the receiver 362 and the stationary arm 364.

The adjustment channel 344 of the adjustable base 340 provides an attachment point for the structure attachment assembly connecting point 118. By sliding the structure attachment assembly connecting point 118 and the fastener 130 along the adjustment channel 344, the overall length of the ladder stabilization clamp 300 may be changed to cover different distances between a ladder and a support structure. The fastener 130 allows for rotational movement between the structure attachment assembly 102 and ladder attachment assembly 304. By tightening the fastener 130, the structure attachment assembly 102 and the ladder attachment assembly 304 can be held at the desired angle and length.

Referring now to FIG. 6b, a side view of an alternative embodiment of the ladder attachment assembly 304 of the ladder stabilization clamp 300 is shown. The ladder attachment assembly 304 includes an adjustable base 340 and a quick release clamp 360. As shown, the adjustable base 340 is integrally formed with the quick release clamp 360 to provide strength, durability, and ease of manufacturing.

The diameter of the quick release clamp 360 can be changed by applying inward pressure and moving the swivel arm 368 to the desired angular position to achieve the desired diameter and tension on the ladder rung 810. The teeth 369 secures the swivel arm 368 in place, preventing inadvertent release of ladder rung 810.

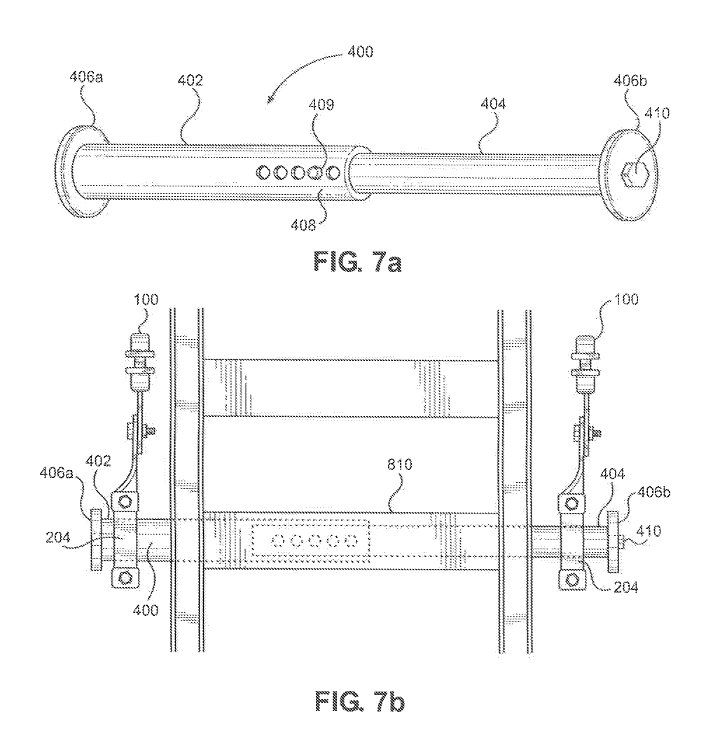

Referring now to FIG. 7a, a front view of an adjustable length rod 400 is shown. The adjustable length rod 400 includes a primary tube 402, a secondary tube 404, end caps 406a and 406b, adjustment points 408, spring actuated stop 409, and a release button 410. The primary tube 402 is a housing for secondary tube 404. The secondary tube 404 is inserted into the center of the primary tube 402 to create a single continuous structure secured to a given length when spring actuated stop 409 is captured within an adjustment point 408. The clearance between the primary tube 402 and the secondary tube 404 is slight, but also allows the tubes to freely move in and out, allowing adjusting the overall length of the adjustable length rod 400. Adjustment points 408 are a series of holes near the end of the primary tube 402. Secondary tube 404 has a spring actuated stop 409. Secondary tube 404 has a release button 410 which when depressed, retracts the spring actuated stop 409 allowing the secondary tube 404 to move freely. The length of the adjustable length rod 400 is adjusted by inserting the secondary tube 404 into the primary tube 402 and aligning the spring actuated stop 409 to a corresponding adjustment point 408 to achieve the desired length of the adjustable length rod 400.

At the end of the primary tube 402 is an end cap 406a. The end cap 406a is a circular piece of material attached or formed to the primary tube 402. In use, the end cap 406a prevents the ladder stabilization clamp 100 from sliding off of the adjustable length rod 400. The secondary tube 404 has a similar end cap 406b that serves the same purpose as end cap 406a. Together, end caps 406a and 406b both prevent the adjustable length rod 400 from sliding out of the ladder rung 810.

Referring now to FIG. 7b, a front view of an adjustable length rod 400 inserted through a ladder rung 810 with a ladder stabilization clamp 100 clamped to each end of the adjustable length rod 400 is shown. The adjustable length rod 400 is passed through the hollow center of a ladder rung 810 and adjusted to allow sufficient contact area upon which the ladder attachment assembly 204 can clamp. The alternative clamping point for the ladder stabilization clamp 100 away from the ladder rung allows a user to climb the ladder without obstructions on the ladder rungs.

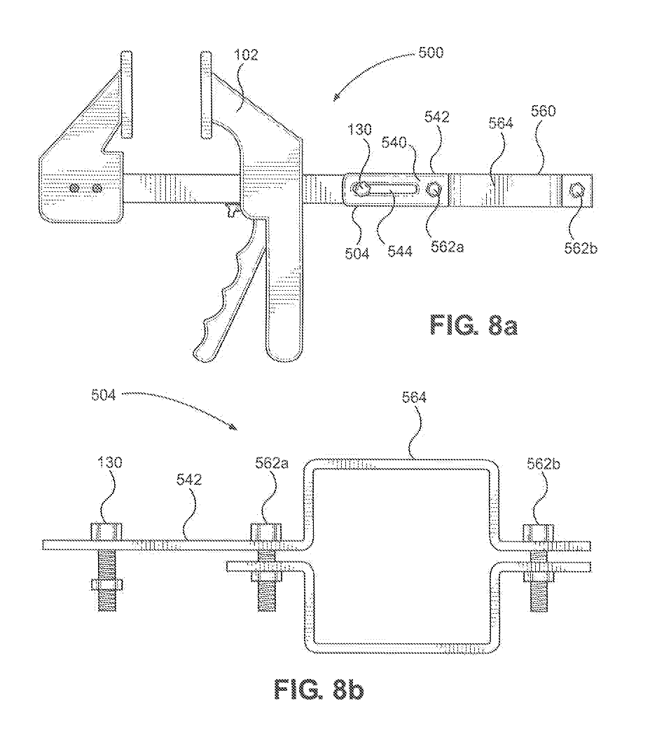

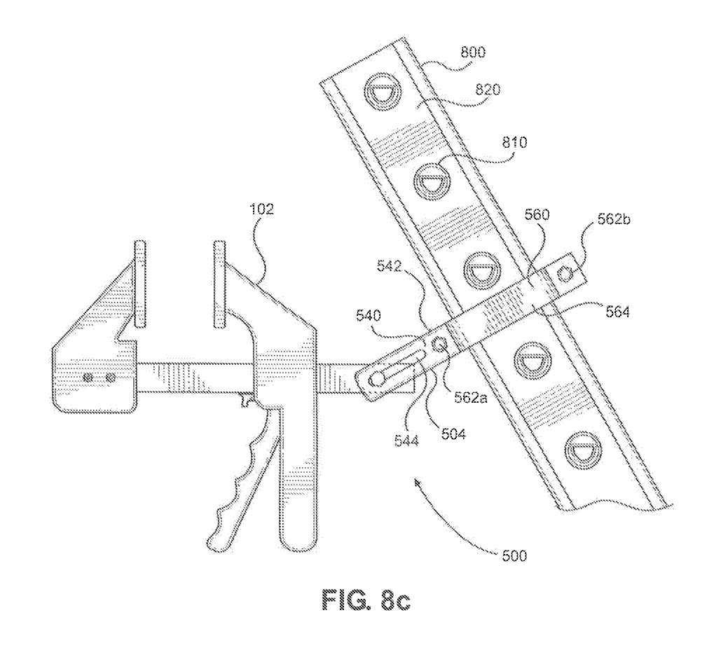

Referring now to FIG. 8a, an alternative embodiment of the ladder stabilization clamp of the present invention is shown and generally designated 500, and includes a structure attachment assembly 102 and a ladder attachment assembly 504. The ladder attachment assembly 504 includes an adjustable base 540 and an adjustable ladder clamp 560. The adjustable base 540 includes a body 542 and adjustment channel 544. The adjustment channel 544 is a channel formed within the body 542 sized to accept fastener 130. The body 542 is integrally formed with the adjustable ladder clamp 560 to provide strength, durability, and ease of manufacturing.

The adjustable ladder clamp 560 includes adjustment screws 562a and 562b and rectangular clamp 564. The rectangular clamp 564 has a rectangular shape and is split in half to create two halves, each half having extended tabs at each end, with each tab having holes. The corresponding holes of the tabs of each half are aligned to create the full rectangular shape. The adjustment screws 562a and 562b are then inserted through the holes. The tightening or loosening of the adjustment screws 562a and 562b will increase or decrease the overall thickness of the rectangular clamp 560.

The adjustment channel 544 of the adjustable base 540 provides an attachment point for the structure attachment assembly connecting point 118. By sliding the structure attachment assembly connecting point 118 and the fastener 130 along the adjustment channel 544, the overall length of the ladder stabilization clamp 500 may be changed to cover different distances between a ladder and a support structure. The fastener 130 allows for rotational movement between the structure attachment assembly 102 and ladder attachment assembly 504. By tightening the fastener 130, the structure attachment assembly 102 and the ladder attachment assembly 504 can be held at the desired angle and length.

Referring now to FIG. 8b, a top view of an alternative embodiment of the ladder attachment assembly 504 of the ladder stabilization clamp 500 is shown. The ladder attachment assembly 504 includes an adjustable base 540 and an adjustable ladder clamp 560. As shown, the adjustable base 540 is integrally formed with the adjustable ladder clamp 560 to provide strength, durability, and ease of manufacturing. In the preferred embodiment, the adjustable base 540 and adjustable ladder clamp 560 is formed using a single flat metal bar strip. At the end of the adjustable base 540, the flat metal bar strip is transitioned into the adjustable ladder clamp 560.

The thickness of the adjustable ladder clamp 560 can be changed by tightening or loosening the adjustment screw 562a and 562b. The tightening or loosening of the adjustment screws 562a and 562b moves the halves of the rectangular clamp 564 towards or away from one another resulting in an increased or decrease of the thickness of the rectangular clamp 564.

Referring now to FIG. 8c, a side view of an alternative embodiment of the ladder stabilization clamp 500 attached to a ladder stile 820 of a ladder 800 is shown. As shown, the ladder attachment assembly 504 is connected to the ladder stile 820 of the ladder 800 by changing the thickness of the rectangular clamp 564 to the thickness of the ladder stile 820 and tightening adjustment screws 562a and 562b, clamping it in place. The width of the rectangular clamp 564 is wide enough to accommodate all types of ladder stiles. The length of the ladder stabilization clamp 500 is adjusted to meet the distance between the ladder stile 820 and the wood fascia 910 of the house 900 by adjusting the adjustable base 540 accordingly.

While there have been shown what are presently considered to be preferred embodiments of the present invention, it will be apparent to those skilled in the art that various changes and modifications can be made herein without departing from the scope and spirit of the invention.

1. (canceled)

2. A ladder stabilization device, comprising:
a structure attachment assembly having an upper jaw assembly and a lower jaw assembly; and
a ladder attachment assembly having an adjustable base and an adjustable ladder clamp;
said structure attachment assembly is mechanically coupled to said ladder attachment assembly to allow movement between said structure attachment assembly and said ladder attachment assembly

3. The ladder stabilization device of claim 2 wherein said upper jaw includes a first end and a second end, said first end of said upper jaw is formed with said upper jaw clamp pad, and said support rail having a first end, a second end, and a predetermined length, said first end of said support rail mechanically fastened to said second end of said upper jaw and said second end of said support rail formed with a ladder attachment assembly connecting point.

4. The ladder stabilization device of claim 3 wherein said lower jaw assembly comprises a lower jaw base and a ratchet handle.

5. The ladder stabilization device of claim 4 wherein said lower jaw base comprises a lower jaw having a first end and a second end, said first end of said lower jaw is formed with an upper jaw clamp pad, said second end of said lower jaw is integrally formed with a stationary handle, a ratchet handle attachment point, a release button, and a slot receiver sized to receive said support rail of said upper jaw assembly, said slot receiver having a means to hold lower jaw base at a point along said predetermined length of said support rail and said means allows the release of said support rail upon pressing said release button.

6. The ladder stabilization device of claim 5, wherein said ratchet handle comprises a body having a top end and a bottom end, said top end formed with a lower jaw base attachment, said lower base attachment is mechanically coupled to said ratchet handle attachment point of said lower jaw base with said bottom end of said body disposed forward of said stationary handle of said lower jaw base at a predetermined angle creating a pivot point and allowing said ratchet handle to rotate towards said stationary handle a predetermined distance to become parallel with said stationary handle, said ratchet handle having a means to incrementally traverse said lower jaw base along said predetermined length of said support rail when said ratchet handle is rotated said predetermined distance.

7. The ladder stabilization device of claim 6 wherein said adjustable base comprises a body and a plurality of adjustment points, said plurality of adjustment points is formed into said body.

8. The ladder stabilization device of claim 7 wherein said adjustable ladder clamp comprises an adjustment loop, having a predetermined length with a first end formed with an adjustment hole and a second end formed with and an adjustment tab, and an adjustment fastener, having an adjustment bolt with a predetermined length and an adjustment nut threaded onto the adjustment bolt to allow movement of said adjustment nut along said predetermined length of said adjustment bolt, said adjustment screw is inserted into said adjustment tab and said adjustment hole of said adjustment loop to vary the opening of said adjustment loop by varying the location of said adjustment nut on said adjustment bolt.

9. The ladder stabilization device of claim 8, wherein said body of said adjustable base is integrally formed with said adjustment loop of said adjustable ladder clamp.

10. The ladder stabilization device of claim 9, wherein said ladder attachment assembly connecting point of said support rail of said structure attachment assembly is mechanically coupled to said adjustment point of said adjustable base of said ladder attachment assembly.

11. The ladder stabilization device of claim 6 wherein said adjustable base comprises a body and an adjustment channel, said adjustment channel is integrally formed with said body.

12. The ladder stabilization device of claim 11 wherein said adjustable ladder clamp comprises an upper clamp, a lower clamp, and a plurality of adjustment fasteners.

13. The ladder stabilization device of claim 12 wherein said upper clamp comprises a body having a predetermined length with a first end having a first adjustment hole and a second end having a second adjustment hole, and said lower clamp comprises a body having a predetermined length equal to said predetermined length of said upper clamp with a first end having a first adjustment hole corresponding to said first adjustment hole of said upper clamp and a second end having a second adjustment hole corresponding to said second adjustment hole of said upper clamp.

14. The ladder stabilization device of claim 13, wherein said plurality of adjustment fasteners includes a first adjustment fastener and a second adjustment fastener, said first fastener includes a first adjustment bolt and a first adjustment screw, said first fastener inserted into said first adjustment hole of said upper clamp and said first adjustment hole of said lower clamp to vary the opening of said adjustment loop by varying the location of said adjustment nut on said adjustment bolt, said second adjustment fastener includes a second adjustment bolt and a second adjustment screw, said second fastener inserted into said second adjustment hole of said upper clamp and said second adjustment hole of said lower clamp to vary the opening of said adjustment loop by varying the location of said adjustment nut on said adjustment bolt.

15. The ladder stabilization device of claim 14, wherein said body of said adjustable base is integrally formed with said body of said upper clamp of said adjustable ladder clamp.

16. The ladder stabilization device of claim 11, wherein said adjustable ladder clamp comprises a receiver and a swivel arm.

17. The ladder stabilization device of claim 16, wherein said receiver comprises a base having a first end and a second end, a stationary arm having a first end and a second end, and a swivel arm receiver, said second end of said base is integrally formed with said first end of said stationary arm and said second end of said stationary arm is formed with a swivel point, and said second end is also formed with said swivel arm receiver, located opposite of said stationary arm.

18. The ladder stabilization device of claim 17 wherein said swivel arm comprises a first end and a second end, said first end of said swivel arm is formed with a swivel point and said second end of said swivel arm is formed with a set of teeth, said swivel point of said swivel arm is mechanically coupled with said swivel point of said station arm to allow rotation of said swivel arm about said swivel point.

19. The ladder stabilization device of claim 18 wherein said swivel arm receiver comprises a means to allow said teeth of said swivel arm to advance through said swivel arm receiver and a means to deny said teeth of said swivel arm to retreat from said swivel arm receiver, said release button allows the release of said swivel arm from said swivel arm receiver when depressed.

20. A method for stabilizing a ladder comprising the steps:
providing a ladder with a plurality of ladder rungs;
providing a support structure;
leaning said ladder against said support structure;
providing a ladder stabilizing clamp having a structure attachment assembly and a ladder attachment assembly;
adjusting the distance of said ladder stabilizing clamp to allow enough distance between said structure attachment assembly and said ladder attachment assembly to attach said structure attachment assembly to said structure and said ladder attachment assembly to a ladder rung of said ladder;
clamping said structure attachment assembly to said support structure;
clamping said ladder attachment assembly to said ladder rung of said ladder;
readjusting the distance between the structure attachment assembly and said ladder attachment assembly to minimize the distance between the structure attachment assembly and the ladder attachment assembly.

21. A method for stabilizing a ladder comprising the steps:
providing a ladder with a plurality of ladder rungs;
providing a support structure;
leaning said ladder against said support structure;
providing a ladder rung attachment comprising a rod with a predetermined diameter having a first end and a second end, a first end cap with a predetermined diameter larger than said predetermined diameter of said rod fixedly attached to said first end of said rod, and a second end cap with a predetermined diameter equal to said first end cap removably attached to said second end of said rod, whereby said second end cap may be removed to allow the insertion of said rod into a ladder rung of said ladder and said first end cap and said end cap prevents said rod from sliding out of said ladder rung;
inserting said ladder rung attachment into said ladder rung;
providing a ladder stabilizing clamp having a structure attachment assembly and a ladder attachment assembly;
adjusting the distance of said ladder stabilizing clamp to allow adequate distance between said structure attachment assembly and said ladder attachment assembly to attach said structure attachment assembly to said structure and said ladder attachment assembly said ladder rung attachment;
clamping said structure attachment assembly to said support structure;
clamping said ladder attachment assembly to said ladder rung attachment;
readjusting the distance between the structure attachment assembly and said ladder attachment assembly to minimize the distance between the structure attachment assembly and the ladder attachment assembly.
